(19) United States
(12) Patent Application Publication
(10) Pub. No.: US 2006/0083039 A1
(43) Pub. Date: Apr. 20, 2006

(54) Power supply system with single phase or multiple phase inverters operating in parallel

(76) Inventors: Marcos Pego de Oliveira, Contagem (BR); Wilton de Castro Padrao, Contagem (BR)

Correspondence Address: LADAS & PARRY, 26 WEST 61ST STREET, NEW YORK, NY, 10023, US

(21) Appl. No.: 10/543,804

(22) PCT Filed: Dec. 23, 2003
(86) PCT No.: PCT/BR03/00204

§ 371 Date: Jul. 29, 2005

(30) Foreign Application Priority Data
Jan. 31, 2003 (BR) PI0300173-3

(51) Int. Cl. H02M 7/537

(52) U.S. Cl. 363/131

(57) ABSTRACT

A power supply system composed by inverters (105, 110, 115) connected in parallel, applicable mainly in uninterruptible power suppliers (UPS). The parallelism provides the capacity of increasing power through the connection of new inverters to the system; and reliability, once defective inverters can be removed of the system without interrupting the power supply, since the total capacity of the remaining inverters is not less than the capacity required by the loads. In a parallelism scenario, one of the inverters assumes the master role, operating as a voltage source, while the other inverters assume the slave role, operating as current sources. The master informs the reference current of each phase to the slaves through a communication bus (150) between inverters (105, 110, 115). The reference is informed as a relative value to master nominal power, allowing the use of inverters with different power in the system and a load distribution proportional to the nominal power of each inverter (105, 110, 115).

### BACKGROUND OF THE INVENTION

Inverters are used for the generation of alternating current electrical power (AC) from a direct current power supply (DC). They can constitute an autonomous product or can be inserted in more complex products, as in the case of an uninterruptible power supply (UPS).

The inverters parallel operation is used normally to increase the capacity of the system power supply and/or to increase the reliability, guaranteeing continuity of the supply even when one or more inverters fail, since the total capacity of the inverters that continue in operation is enough to supply power to the loads. The control of this parallelism is a complex task, once any disequilibrium can cause an exchange of active or reactive power between the inverters. The most common process that carries through this parallelism uses reactors in the inverters outputs and control of the supply through inclined straight lines relating voltage with the supply of reactive power and frequency with the supply of active power (patents U.S. Pat. No. 6,356,471 B1, U.S. Pat. No. 6,452,290 B1 and U.S. Pat. No. 6,381,157 B2). This process, however, deteriorates the system's dynamic response, and adds extra costs with the inclusion of the reactors. This characteristic is particularly important when the system supplies power to non-linear loads as, for example, switching power supplies used in computer related products, which cause current circulation with high harmonic distortion. The power supply impedance must be low, to assure the supply of energy with quality, keeping the same harmonic distortion in the output voltage of the system low.

Another technique monitors the difference between the average current of the system and the value of the current in each inverter (patent U.S. Pat. No. 5,745,356). The control tries to make this difference equals to zero when compared to the average current, when each inverter will be contributing with the same power. However, the implementation of this technique demands a complex interconnection of control signals between the inverters.

### SUMMARY OF THE INVENTION

The present invention consists of a power supply system with inverters operating in parallel, where an inverter assumes the master role, operating as a voltage source and the other inverters assume the role of slaves, operating as current sources. This technique prevents extra components or high value inductors in the power part, keeping the same dynamic response capability of the inverters when MAIL LABEL operating individually. Communication buses between the inverters are implemented so that the master informs the reference current to the slaves. These inverters can be single-phase or multiphase, with more common application in three-phase inverters.

### DESCRIPTION OF THE DRAWINGS

FIG. 1 illustrates the system embodying the present invention, with inverters in parallel supplying power to an AC bus, to which the loads are connected.

FIG. 2 shows, with more details, the structure of the inverter output, highlighting the points of interest for understanding the present invention.

FIG. 3 presents the control structure of an inverter acting as master.

FIG. 4 presents the control structure of an inverter acting as slave.

### DETAILED DESCRIPTION

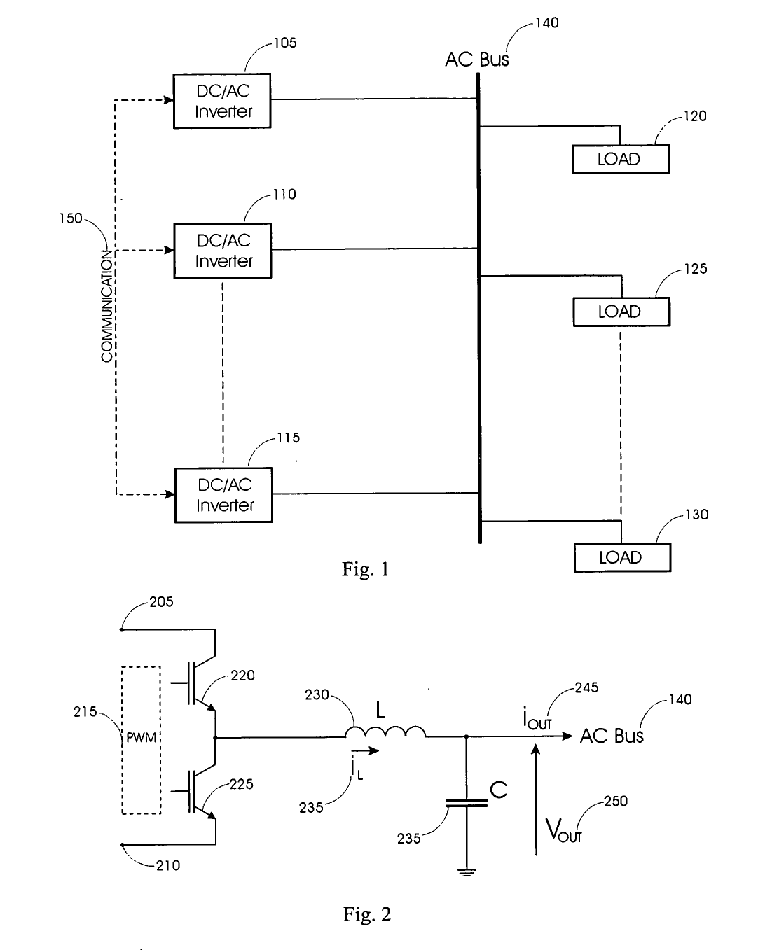

FIG. 1 illustrates the present invention, which consists of a system composed by direct current to alternate current inverters, or DC/AC inverters, 105, 110 and 115 with its outputs connected in parallel to a common AC bus 140 for supplying power to loads 120, 125 and 130. In addition to the power connection, the inverters are also connected to a communication bus 150. FIG. 2 presents an inverter output stage. The PWM block 215 allows the control of switches 220 and 225, modulating the direct current bus, represented by V+ 205 and V− 210. These switches are implemented with semiconductors, preferentially of IGBT type, but other technologies can also be used, such as bipolar transistor, FET or MOSFET. The inductor L 230 and the capacitor C 240 represent the output filter of the inverter. Some measures are collected for control: current IL 235, output current IOUT and the output voltage VOUT 250. Alternatively one of the current measures IL 235 or IOUT 245 can be substituted by the current measured in capacitor C 240, once we can get obviously the three current values measuring only two. To make the understanding easier, this description assumes that the inverters are single-phase. In case of multiple-phase inverters, the principle adopted is the same, treating each phase as a set of single-phase inverters.

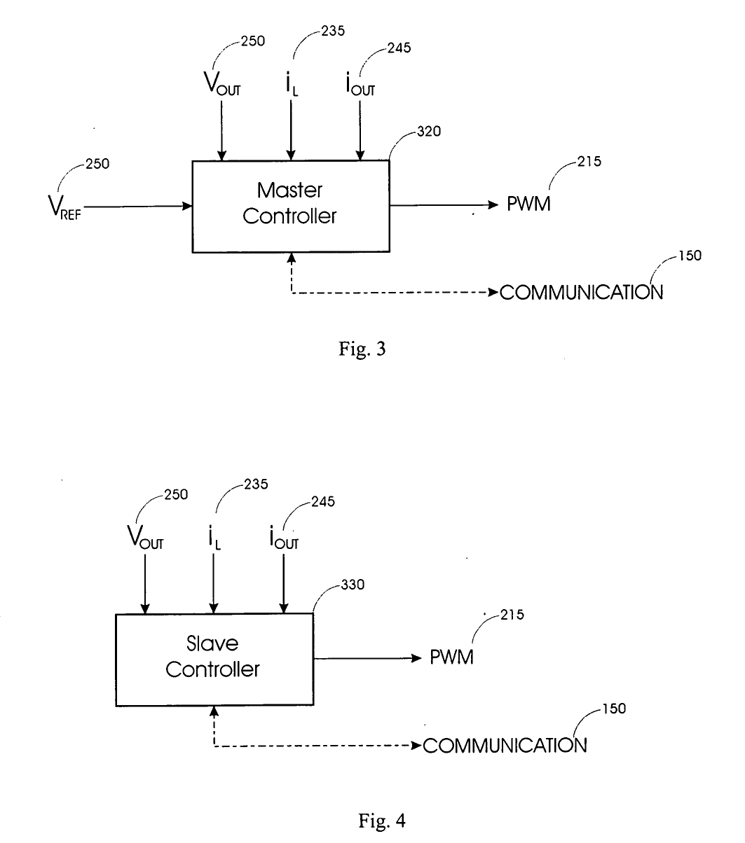

Each inverter has a PWM controller 215. In the present invention, the difference in the operating mode of this controller is what allows the inverters operation in parallel. An inverter assumes the master role, operating as voltage source, keeping its frequency and amplitude according to its specification. FIG. 3 presents the operation of the Master Controller 320. Its function is to act on the control PWM 215, based on the information of VOUT 250, IL 235 and IOUT 245, such that the output voltage VOUT 250 is equal to the voltage reference VREF 310. The Master Controller 320 also calculates the relative value of IOUT 245 related to its nominal capacity and transmits to the other inverters through the communication bus 150. Alternatively, the Master Controller 320 can generate as byproduct of its action of control, a reference current in the inductor, necessary to have VOUT 250 equal to VREF 310. This reference current, calculated as a relative value to the nominal capacity of the master inverter, is transmitted to the other inverters through the communication bus 150. In case of multiphase inverters, the Master Controller 320 transmits the reference of each phase to the slave inverters.

The other inverters of the system assume the slave role, operating as current sources and use the information of the master as a reference to define the current to be supplied. FIG. 4 presents the operation of the Slave Controller 330. Its function is to act on the control PWM 215, based in the information of VOUT 250, IL 235 and IOUT 245, in a way that the output current IOUT 250 is equal to the reference current received from the master inverter through the communication bus 150. This way, each inverter assumes the same percentile value in relation to its nominal capacity. This allows the connection of different power inverters to the AC bus, with the division of the loads proportional to the power of each one. The communication bus 150 must allow the exchange of data in the necessary rate and in real time, and it can be implemented using different protocols, for example RS-485, CAN, TTP/C, TTP/A, FlexRay, and Ethernet. The CAN protocol is recommended since it contemplates these requirements; it provides immunity to noises and a fault tolerance capability, and it is already integrated in a great number of microcontrollers and digital processors of signals (DSP), components commonly used in the implementation of the controllers.

The inverters connected to the system have a unique identification, which identifies them in the communication bus 150. Any DC/AC inverter 105, 110 and 115 can operate as master or as slave. Preferentially, the inverter with the smallest identification order assumes the master role and the others became slaves. In case of a problem with a slave inverter, it simply stops contributing to the power supply, generating, as a consequence, a new load distribution between the inverters in operation.

In case of a problem with the master inverter, it stops contributing to the power supply and a slave inverter assumes the master role, preferentially the inverter with the smallest identification order, excluded the master that is being substituted. New inverters can be connected to the system at any time, assuming, preferably, the slave role, independently of its identification order.

1- Power supply system with single phase or multiple phase inverters operating in parallel, characterized by the fact that only one inverter operates as a voltage source, wile the other inverters operate as current sources and their reference is the instantaneous current in each output phase of the inverter operating as a voltage source.

2- Power supply system with single phase or multiple phase inverters operating in parallel according to claim 1, characterized by the fact that the current in each output phase of the inverter operating as a voltage source is transmitted through a communication mechanism present between the inverters, such as a CAN interface or any other equivalent mechanism.

3- Power supply system with single phase or multiple phase inverters operating in parallel according to claim 1, characterized by the fact that the reference current for each output phase of the inverters operating as a current source is received through a communication mechanism present between the inverters, such as a CAN interface or any other equivalent mechanism.

4- Power supply system with single phase or multiple phase inverters operating in parallel according to the previous claims, characterized by the fact that in case of a failure in the inverter operating as the voltage source, another inverter assumes its role, not operating as a current source anymore, but as a voltage source, transmitting the data for the other inverters which will keep working as current sources.

5- Power supply system with singe phase or multiple phase inverters operating in parallel according to the previous claims, characterized by a power distribution proportional to the nominal capacity of each inverter in operation.
